(19) United States
(12) Patent Application Publication
(10) Pub. No.: US 2012/0051694 A1
(43) Pub. Date: Mar. 1, 2012

(54) OPTICAL WAVEGUIDE FOR TRANSMISSION OF RADIATION, AND PRODUCTION METHOD

(76) Inventor: Hubertus Russert, Heidenrod (DE)

(21) Appl. No.: 13/202,268

(22) PCT Filed: Jan. 26, 2010
(86) PCT No.: PCT/EP2010/000432

§ 371 Date: Oct. 31, 2011

(30) Foreign Application Priority Data
Feb. 18, 2009 (DE) 10 2009 009 367.2

(51) Int. Cl. G02B 6/32; B29D 11/00; G02B 6/42

(52) U.S. Cl. 385/33; 385/31; 264/1.28

(57) ABSTRACT

An optical waveguide for transmission of radiation, in particular of the radiation from a high-power diode laser, and a method for its production are provided. The optical waveguide has an elongated light inlet surface, which is in the form of a gap, consisting of one or more layers of optical fibers, with the fibers being connected at least partially in an form-closed manner to one another and to a mounting plate.

The invention relates to an optical waveguide for transmission of radiation, in particular of the radiation from a high-power diode laser, and to a method for its production.

High-power diode lasers are generally composed of one or more so-called laser bars, with each laser bar having a multiplicity of emitters with a light output surface in the form of a gap, which are arranged alongside one another along the semiconductor junction on the laser bar. A single emitter has a very small extent of only about 1 μm in the direction of the semiconductor junction, the so-called fast axis, and an extent of typically 100 μm to 200 μm parallel to the semiconductor junction, on the so-called slow axis. On the fast axis, the emitted radiation has a wide divergence angle of typically 20° to 30° with respect to the half angle, and a considerably reduced divergence angle of typically 5° on the slow axis.

Extensive prior art exists relating to the input from semiconductor lasers into optical waveguides. All the concepts have the common aim of inputting the emitted radiation from the semiconductor laser into one or more fibers with coupling losses which are as low as possible and with the beam quality being maintained as well as possible, in which case the beam quality can be described by the product of the beam diameter and the divergence, the so-called beam parameter product. The beam quality describes how well the radiation of a laser can be focused, and is of critical importance for most applications. The higher the beam quality is, the lower is the beam parameter product, and vice versa.

According to fundamental physical laws, the beam parameter product can never be reduced, not even by optical elements or other means. Correspondingly, the beam quality cannot be improved. In particular, however, the beam quality can be reduced during beam guidance and shaping using non-imaging optical elements. Because the emitters are in the form of a gap and because of the different beam divergences on the slow and fast axes, the process of inputting the emitted radiation into optical fibers while maintaining the beam quality as well as possible represents a demanding problem, not least because optical fibers generally have a round cross-sectional shape.

When inputting the divergent radiation from a semiconductor laser into optical fibers, a fiber type must be chosen with a sufficiently high numerical aperture (NA), which can receive all of the radiation. In this case, the NA indicates the sine of the maximum half angle of a light beam relative to the fiber axis which is still transmitted by the fiber. The half angle of the laser radiation on the fast axis of 20-30° corresponds to an NA of 0.34 to 0.5, and the half angle on the slow axis corresponds to an NA of 0.09.

When inputting the laser radiation into optical fibers which have a lower NA than that of the laser radiation on the fast axis—for example with an NA of 0.22 in a standard quartz fiber—the laser radiation must be collimated on the fast axis before the input, and this can be done, for example, by the introduction of micro-optics, in particular of cylindrical lenses, or else by non-imaging optics such as light guide rods with a cross section which widens in the propagation direction of the light, such as a conical cross section. If the radiation is not collimated on the fast axis, only a proportion of the laser radiation will be carried within the NA of the fiber. The component of the laser radiation which is input into the fiber at greater aperture angles will be emitted from the fiber, and can lead to thermal damage, and therefore to destruction of the optical input end.

Alternatively, it is also possible to use fibers with a sufficiently high NA, which can receive all of the laser radiation. In this case, the wide divergence of the semiconductor laser is accepted. This solution has the advantage that, in this case, there is no need for complex micro-optics and for positioning them, and the fibers can be coupled directly to the emitter. This is also referred to as butt coupling. A corresponding embodiment can be found, for example, in DE 102005057617 A1, and this solution is furthermore distinguished in that each emitter has a multiplicity of associated fibers. In addition to butt coupling, this embodiment is also distinguished by the radiation being input into a fused fiber bundle, that is to say the optical fibers are connected to one another in an form-closed manner in the input surface. The fusion of the fibers on the one hand increases the coupling efficiency, since this avoids the need for area components for the fiber intermediate spaces between the fibers, while on the other hand this avoids the use of adhesives in the area of the input surface, which is unacceptable due to the high power densities of the high-power semiconductor laser.

In order to avoid unnecessarily reducing the beam quality, it is also important for the laser beam to be guided with a beam diameter which is as small as possible, that is to say to be input into an optical waveguide with as small a light-guiding cross-sectional area as possible. By way of example, U.S. Pat. No. 4,763,975 discloses a concept in which a single coupling element, which has an elongated oval light input surface and a round output surface, is positioned before the entire laser bar with a plurality of emitters. In this concept, the cross-sectional area of the laser beam is enlarged considerably and irreversibly, since this results in non-imaging optics. The beam quality is therefore greatly reduced. Furthermore, there are concepts in which each emitter is associated with a single fiber with a round cross-sectional profile. Since, in this case, the fiber diameter must be chosen to be relatively large, corresponding to the emitter width, this concept is also distinguished by a major increase in the total fiber cross-sectional area relative to the cross-sectional area of all the emitters, and therefore likewise by a reduction in the beam quality. In a further embodiment with an improved cross-sectional area, each emitter is associated with a rectangular single fiber (U.S. Pat. No. 5,629,997). However, in this case of rectangular individual fibers, the availability of the rectangular fibers with a sufficiently high NA represents a problem, and, in addition, the positioning of the individual fibers in front of the emitters involves a very large amount of effort.

A further variant in DE 102004006932 B3 provides for individual fibers with a rounded cross section to be arranged flush alongside one another in a monolayer, and for the monolayer to be fused to a rectangular cross section in a hot-pressing process, with the individual fibers in the monolayer assuming a rectangular cross section. An optical element is then integrally formed onto the free end of the fused fibers in a grinding process using a grinding tool, and in the example the optical element is an intrinsic cylindrical lens, as known from the prior art or else a cone. Both elements in this case carry out the function of angle collimation on the fast axis. The individual fiber diameter is in this case chosen such that, with butt coupling, each emitter in the bar is associated with a multiplicity of deformed individual fibers.

However, the input end described according to that in DE 102004006932 B3, and in particular its production, has a multiplicity of disadvantages and reservations with regard to feasibility. From experience, the deformation of optical fibers in direct contact with a pressing tool leads to major problems. When using a pressing tool without a special surface quality, the fibers are normally so severely damaged by deformation of the optical interface that the light guidance is extremely restricted, and a large proportion of the laser radiation would be emitted from the fibers. Furthermore, a person skilled in the art is aware that adhesion or even sticking of the optical fibers to the pressing tool must be expected, and the disclosure does not describe any means for preventing these effects. Furthermore, after a thermal shaping process, the mechanical strength of optical fibers is greatly reduced, as a result of which the application of a grinding process to the single-layer-fused fiber strip, as is described in the disclosure, and a necessary polishing process are impossible without fracturing occurring. It can therefore be assumed that the component described in this document cannot be produced, or cannot be produced economically, in the described manner.

The object of the invention is therefore to provide an optical waveguide in particular for inputting of the radiation from high-power diode lasers, having an input surface which is as small as possible, is in the form of a gap and is virtually completely filled with fused fibers in which case the input end should be sufficiently robust for the entire production process. A further object of the invention is to provide a suitable method for production of the corresponding optical waveguide, in which case, in particular, a further aim is also to allow fusion of a monolayer of fibers with as little damage as possible to the fibers, and with their light-transmitting properties being influenced as little as possible.

The object is achieved by the independent claims. Preferred embodiments are specified in the dependent claims.

The object of the invention is achieved by an optical waveguide containing a plurality of optical fibers having an input end and one or more output ends, with the input end having a fusion zone, in which the fibers are at least partially connected to one another in an form-closed manner, adjacent thereto, a transition zone, in which the cross section of the optical fibers changes from a substantially polygonal shape to a substantially circular shape, and adjacent thereto, an outlet zone, in which the fibers have a substantially circular cross-sectional shape, characterized in that the fibers are arranged in a monolayer or else a plurality of layers on a mounting plate, and the fibers in the lowermost layer in the area of the fusion zone are connected in an form-closed manner to the mounting plate. On the one hand, the arrangement of the fibers on the planar mounting plate results in the input end having a cross-sectional area in the form of a gap. On the other hand, the arrangement of the fibers on the mounting plate, to which the fibers are connected in an form-closed manner, results in the input end being sufficiently mechanically robust to allow appropriate end surface machining of the input end. In this case, to be more precise, an form-closed connection means that the fibers are connected to one another and to the mounting plate over an area, and that any air-filled intermediate spaces which exist between the fibers before the shaping process, also referred to as gaps, still exist after the shaping process only to a very minor relative extent of less than 5% with respect to the form-closed connected cross-sectional area. Furthermore, the form-closed connection may also be integral, in which case it is then possible to speak of fusion of the fibers. However, in general, an form-closed connection of the fibers provides the optical waveguides according to the invention with sufficient robustness for the subsequent process steps. In general, these process steps include end surface machining. In general, the end surface machining comprises grinding and polishing processes which represent a severe mechanical load on the fibers and for this reason are predicated on appropriate robustness in order to prevent shelling defects and break-outs on the end surfaces of the fibers. In general, the mechanical robustness of the fibers in the area of the deformed, non-round fiber cross section is poor, since the optical fibers are reduced to an extreme extent by a hot-pressing process as is preferably used for the production of the optical waveguide according to the invention. During the hot-pressing process, the individual fibers therefore lose their prestressing, with which they have been provided because of the extremely rapid cooling-down after the fiber drawing process. Furthermore, numerous microscopic cracks and microscopic damage areas are introduced into the fiber surface as a result of which, in contrast to drawn fibers, the deformed fibers are very brittle, and fracture at low mechanical load levels. Any mechanical load on the deformed fibers must therefore be avoided, and this is achieved in the present invention by the form-closed connection to the mounting plate.

In the non-deformed area, the fibers have a substantially round cross-sectional shape. However, the production process may result in discrepancies from the round cross-sectional shape, with ovality, for example, being present. In contrast, in the fusion zone, in the areas in which the fibers are connected in an form-closed manner, the individual fibers have a substantially polygonal cross-sectional shape. In the case of a single-layer arrangement in the fusion zone, the fibers can therefore preferably have quadrilateral, rectangular cross sections with rounded corners, which have an approximately rectangular shape. In contrast, in the case of multilayer fiber ribbons, hexagonal and pentagonal cross-sectional shapes are preferably formed in the fusion zone. The fibers are in general connected to one another in an form-closed manner, but not necessarily with an integral or material joint. This means that, in general, the fibers are not permanently fused to one another but form a structure which is firmly cohesive and adheres to the mounting plate.

The mounting plate need not necessarily be in the form of a plate. The important factor is for at least one surface to have a planar area which is connected in an form-closed manner to the fibers. In general, a mounting plate therefore also means a mounting element of any desired shape with at least one planar surface section.

In one preferred embodiment, the optical fibers are step-index multimode glass fibers with a uniform fiber diameter D, wherein the ratio of the cladding thickness of the optical fibers to the intended application wavelength is less than 5, particularly preferably between 0.5 and 3. In principle, the optical waveguide according to the invention can be produced using a multiplicity of optical fiber types. For example, it is possible to use quartz fibers in conjunction with a suitable material for the mounting plate, or else to use plastic fibers, in which case the fibers may be of the monomode or multimode type. Step-index multimode glass fibers consisting of at least two multi-component glasses are preferably used, in general comprising a core glass with a refractive index n_{K} and a cladding glass with a lower refractive index n_{M}, in each case with respect to the wavelength being used. These fiber types allow high temperature resistance levels of about 300° C.-400° C. to be achieved, as well as the required numerical apertures for butt coupling of a semiconductor laser. Furthermore, step-index multimode glass fibers having a core-cladding ratio that is as high as possible are preferably used, that is to say a maximum area component of the optical core and a minimum area component of the optical cladding with respect to the fiber cross-sectional area. The ratio of the thickness of the optical cladding, also referred to as the cladding thickness, with respect to the intended wavelength to be used is in this case preferably chosen to be less than 5, particularly preferably between 0.5 and 3. The cladding area components on the input surface of the optical waveguide, and therefore the optical input losses, are thus kept as low as possible. The risk of thermal damage to the input end is likewise kept low. If the cladding thickness is less than half the light wavelength, the optical losses through the cladding are in contrast sufficiently great that a significant proportion of the radiation can leave the fibers through the cladding (optical tunneling), and this can likewise lead to thermal damage to the optical waveguide. The fiber diameter preferred according to the invention is in the range 30 μm to 100 μm, although it is also possible to use fibers with a larger or smaller fiber diameter. Fibers with a uniform fiber diameter are preferably used. Uniform fiber diameters should in this case be understood to mean that the discrepancies in the fiber diameters of the individual fibers vary substantially within normally unavoidable manufacturing tolerances, which typically do not exceed 10% of the fiber diameter D.

In one preferred embodiment, the linear thermal expansion in the temperature range 20° C. to 300° C. of the mounting plate is at most 3·10⁻⁶/K less than, but preferably greater than, that of the cladding glass of the optical fibers. The mounting plate on which the fibers are pressed plays a central role. Since the fibers are connected in an form-closed manner to the mounting plate, the thermal expansion of the mounting plate must be matched to that of the fibers. In particular, the different thermal expansion of the fibers and mounting plate must not lead to the formation of mechanical tensile stresses in the pressed fiber bundle, which can result in fiber fractures. The most robust fusions are achieved if the thermal expansions of the mounting plate, the cladding glass and the core glass are relatively similar, that is to say they differ by at most 2·10⁻⁶/K from one another. Stable fusions are likewise achieved simply if the thermal expansion of the cladding glass of the fibers is considerably less than that of the mounting plate since, in this configuration, only compression stresses occur in the fiber surface, that is to say in the cladding glass, which cannot cause fiber fracturing. However, it is undesirable for the thermal expansion of the cladding glass to considerably exceed that of the mounting plate, since tensile stresses can then be formed in the fibers. Based on trials with various fiber types and mounting plates, robust fusion requires that the thermal expansion in the temperature range 20° C. to 300° C. of the mounting plate be at most 3·10⁻⁶/K less than, but preferably greater than, that of the cladding glass of the optical fibers. This condition avoids critical tensile stresses on the surface of the optical fibers, which are connected in an form-closed manner to the mounting plate. When a cover plate is present, corresponding conditions also apply to it.

In one preferred embodiment, the fibers are fixed by suitable means, preferably by an adhesive, relative to the mounting plate in the area of the outlet zone and/or the transition zone. Mechanical loading of the fibers in the input end, and therefore damage, are reliably precluded by the fibers being fixed relative to the mounting plate in the outlet and/or the transition zone, in addition to the form-closed connection in the fusion zone.

In a further preferred embodiment, that surface of the mounting plate which faces the fibers has a mean roughness depth R_{z}<1 μm, and particularly preferably R_{z}<0.2 μm. Since the mounting plate and, if present, the cover plate are connected in an form-closed manner to some of the fibers during the hot-pressing process, their surfaces are transferred to the optical interfaces of the fibers, that is to say to the interface between the core glass and cladding glass. If the mounting plate or cover plate is rough or rippled, then the optical interface is in general deformed in such a way that the light-guiding properties of the fibers are greatly reduced. The mounting plate and cover plate therefore preferably have a planar and polished surface on the sides facing the fibers. To this end, the value of the mean roughness depth R_{Z} in accordance with DIN EN ISO 4287:1998 must be less than 1 μm, and preferably less than 0.2 μm. An appropriate surface quality can be produced, for example, for metallic mounting plate materials by grinding and polishing processes, and also, for example, by etching processes for semiconductor materials such as silicon. Semiconductor materials such as these can also be used as a mounting plate, and are covered by the invention. However, in one preferred embodiment of the invention, a glass plate, in particular a float glass plate, is used, which satisfies the requirements not only for thermal expansion but also those for the high surface quality.

In a further preferred embodiment, the mounting plate is composed of a glass type whose softening temperature E_{W} is above the highest E_{W} of the glass types used in the optical fibers, preferably at least 50 K above the highest softening temperature E_{W} of the glass types used in the optical fibers. The fibers should not be molded into the mounting plate during the hot-pressing process that is preferably used, in order to form an input surface which is as exactly in the form of a gap as possible. Since, for example, the hot-pressing process is carried out at a temperature which corresponds to the softening temperature of the glass types used in the optical fibers, the softening temperature of the glass type for the mounting plate must therefore be higher than the softening temperature E_{W} of the glass types used in the optical fibers, preferably by at least 50 K. This requirement can likewise be ensured by using commercially available float glasses. If the fibers are quartz fibers, quartz glass can likewise preferably be used as the material for the mounting plate since no suitable glass types with a correspondingly higher softening temperature are available.

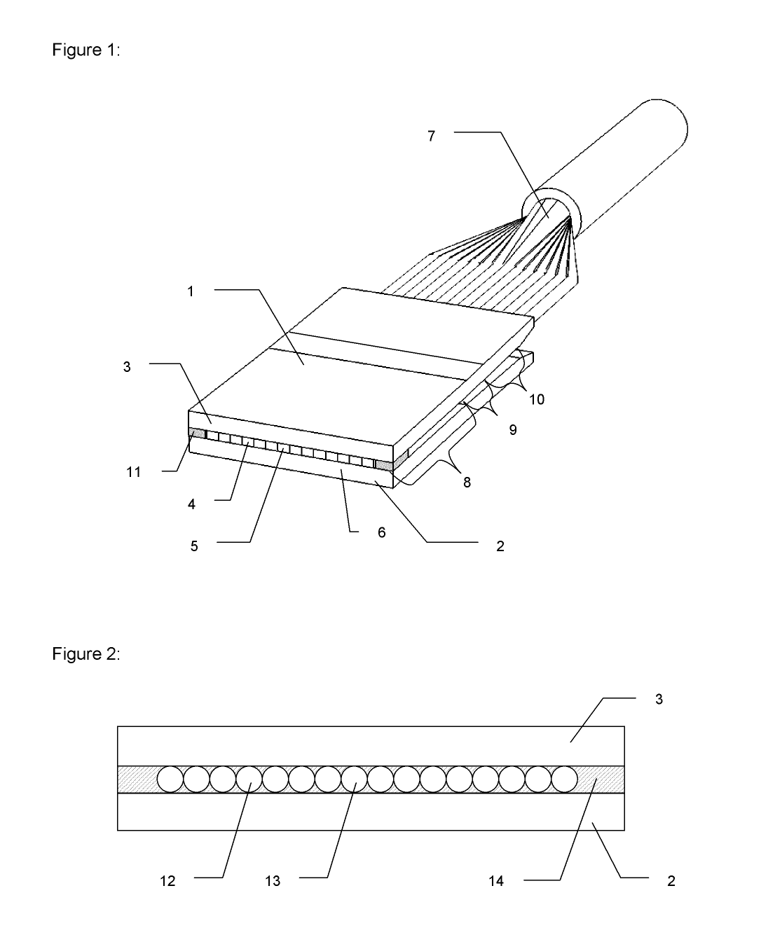

In one preferred embodiment, the optical fibers are arranged in one layer, parallel and flush in the area of the transition zone and the fusion zone, and have an approximately rectangular cross section in the area of the fusion zone, are moreover arranged there in an form-closed manner and together form an input surface in the form of a gap, whose height is between 60% and 90% of the fiber diameter D. This embodiment is illustrated schematically in FIG. 1 and in FIG. 4. The embodiment results from the shaping of the fiber ribbon, which is arranged in one layer, parallel and flush, subject to the constraint according to dependent claim 11. In this embodiment, the height of the input surface, which is in the form of a gap, is already predetermined by the fiber diameter, and is in theory 78.5% of the fiber diameter. In practice, greater or lesser heights of the input surface can also be achieved as a result of fiber diameter tolerances, overcompression or undercompression of the fiber bundle. In comparison to the following further embodiments, this embodiment represents the preferred variant since it can be manufactured most easily.

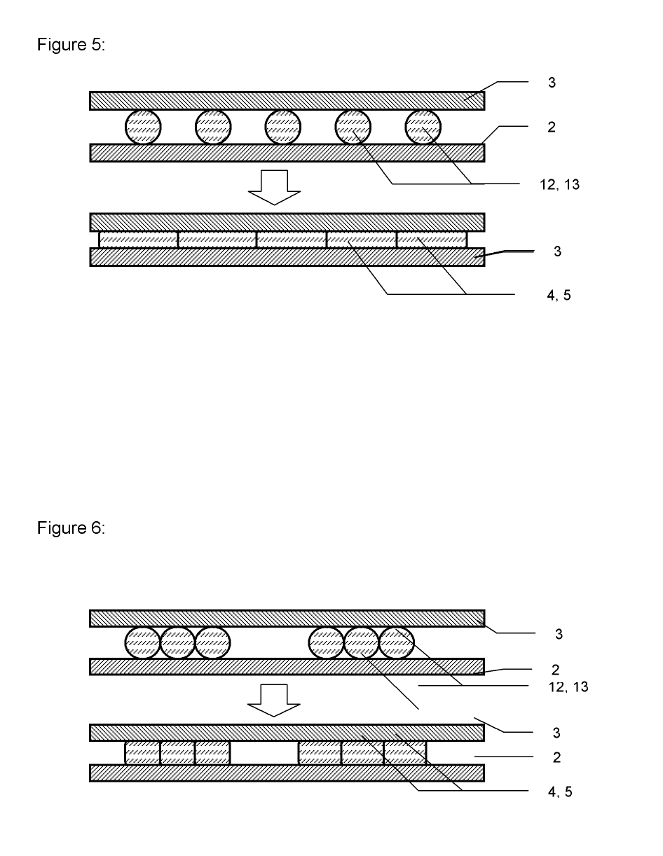

A further preferred embodiment is characterized in that the optical fibers are arranged in one layer, parallel and parallel at uniform intervals in the transition area from the outlet zone to the transition zone, with two fibers each being separated by 0 to five times the fiber diameter D, being arranged in an form-closed manner in the area of the fusion zone, and together forming an input surface in the form of a gap, whose height is between 15% and 90% of the fiber diameter D. This embodiment is illustrated schematically in the lower part of FIG. 5. For a predetermined fiber diameter, this embodiment allows the input surface to have a reduced height, since the individual fibers abut against the adjacent fibers only after considerably greater deformation. However, this variant involves more manufacturing effort since the fibers have to be positioned exactly before fusion.

A further preferred embodiment is characterized in that, after coupling the optical waveguide to a laser diode bar having a plurality of emitters and non-emitting areas between the emitters, only those fibers into which laser radiation is input are combined in an output end, and fibers in which no laser power is input are not supplied to an output end. The optical waveguide according to the invention is preferably coupled to a semiconductor laser having a plurality of emitters, with the input surface, which is in the form of a gap, of the optical waveguide being butt-coupled to the emitter row, or else being coupled to the emitter row via optical elements. In this case, one or more fibers on the input surface are associated with one emitter or else the non-emitting area between two emitters, depending on the emitter width, the emitter separation, the fiber diameter and the height of the input surface. The fibers into which no laser power is input can be identified after coupling of the semiconductor laser and permanent fixing of the input end and semiconductor laser, and can be removed and/or cut out of the fiber bundle. This reduces the total cross-sectional area of the fiber bundle on the output side, correspondingly optimizing the beam quality.

A further preferred embodiment is characterized in that the optical fibers are arranged in one layer, parallel and in groups of 1 to 5 fibers each in the transition area from the outlet zone to the transition zone, and the fibers of in each case one group are arranged in an form-closed manner in the area of the fusion zone, with one group of fibers in each case being associated with one emitter during the subsequent coupling of the optical waveguide to a laser diode bar, and with no fibers being arranged in the areas of the input surface which are associated with the surface between two emitters during the subsequent coupling of the optical waveguide to a laser diode bar. This embodiment is illustrated schematically in the lower part of FIG. 6. In this embodiment, there is no need to remove from the bundle fibers into which no radiation need be input after coupling to a semiconductor laser, as described in the previous embodiment. However, the groups of fibers must be arranged to exactly match the distance between the emitters.

A further preferred embodiment is characterized in that the input surface is filled in an form-closed manner with the optical fibers, and the combined cross-sectional area of the individual fibers in the fusion zone corresponds essentially to the combined cross-sectional area of the individual fibers in the outlet zone, or is at most 25% less than this. This preferred embodiment includes the optical fibers being compressed neither too little nor too much during the hot-pressing process. The preferred embodiment can also be interpreted as meaning that the air-filled intermediate spaces between the fibers before the hot-pressing process are actually eliminated by the hot-pressing process and that, furthermore, no further compression is carried out anymore. This therefore means that neither undercompression nor overcompression occur.

If, in the event of undercompression, the cross-sectional area is not filled with the optical fibers in an form-closed manner, this results in input losses resulting from radiation being input into the intermediate spaces between the fibers. Furthermore, the input end is less mechanically robust. If the bundle cross section is compressed to a greater extent in the event of overcompression, it is in contrast possible for the light-guiding characteristics of the fiber ribbon to be severely adversely affected, since the fibers may be compressed in the axial direction during the fusion process because of a material flow which then occurs in the direction of the fiber axis. The compression of the fibers may also result in deformation of their optical interface, resulting in the described adverse effect on the light-guiding characteristics. However, in an individual case and depending on the material combination, it may be advantageous for the total cross-sectional area of the individual fibers in the fusion zone to be slightly less than, or at most 25% less than, the total cross-sectional area of the individual fibers in the unfused fiber bundle, that is to say to be slightly overcompressed. By way of example, this makes it possible to compensate for fluctuations in the individual fiber diameters, or to improve the form-closed connection and fusion.

A further preferred embodiment is characterized in that the fibers are connected in an form-closed manner on their upper face to a cover plate in the fusion zone. In one preferred embodiment of the invention, the fibers are covered by a cover plate, at least in the area intended for the fusion zone, before the hot pressing process, thus resulting in a three-layer structure after the hot-pressing process, consisting of a mounting plate, one or more fiber layers and a cover plate. The height of the input surface then corresponds to the distance between the mounting plate and the cover plate. After the hot-pressing process, a cover plate carries out the task of making the input end more robust. Furthermore, the use of a cover plate avoids a direct contact between the upper pressing stamp or a separating means and the optical fibers. However, it is not essential to provide a cover plate. The cover plate need not necessarily be in the form of a plate. The important factor is the planar surface which makes contact with the fibers. In general, therefore, a cover plate also means a cover element of any design shape which has at least one planar surface.

A further preferred embodiment is characterized in that that surface of the cover plate which faces the fibers has a mean roughness depth of R_{z}<1 μm, particularly preferably R_{z}<0.2 μm, and in that the linear thermal expansion in the temperature range 20° C. to 300° C. of the cover plate is at most 3·10⁻⁶/K less than, but preferably greater than, that of the cladding glass of the optical fibers, and in that the cover plate (3) is of a glass type whose softening temperature E_{W} is above the highest E_{W} of the glass types used in the optical fibers, preferably at least 50 K above the highest softening temperature E_{W} of the glass types used in the optical fibers. Said characteristics have already been explained in conjunction with the mounting plate. The mounting plate and cover plate may both be composed of the same material, and may also have the same dimensions.

A further preferred embodiment of the optical waveguide according to the invention is characterized in that further optical means such as accessory lenses or intrinsic cylindrical lenses are fitted in front of the inlet surface, or the input surface is provided with an antireflective coating. These optical elements can improve the input efficiency, in particular of laser radiation into the input end.

The subject matter of the invention also includes the provision of a method for producing the optical waveguide according to the invention. The method according to the invention for producing an optical input end of an optical waveguide comprising a multiplicity of optical fibers having a substantially circular cross section in the initial state is characterized in that the optical fibers are arranged and fixed in one or more layers on a mounting plate, the fibers are then reshaped, using a hot-pressing process, with force and heat being introduced, at least in a subarea of the mounting plate, such that the optical fibers are connected to one another at least in groups in an form-closed manner, and the lowermost layer of the fibers is connected in an form-closed manner to the mounting plate, thus resulting in a fusion zone in which the fibers are connected to one another at least in groups in an form-closed manner, and the lowermost layer of the fibers is connected in an form-closed manner to the mounting plate, a transition zone, which is adjacent thereto and in which the cross-sectional shape of the optical fibers changes from a substantially polygonal shape to a substantially circular shape, and an outlet zone, adjacent thereto, in which the optical fibers have a substantially circular cross-sectional shape.

In the following description, the method will be explained in the process steps of prefabrication, hot pressing and fabrication.

The prefabrication comprises the provision of fibers and a mounting plate, as well as the arrangement and fixing of the fibers on the mounting plate. The fibers are arranged in one or more layers on the mounting plate, preferably with a width which corresponds to the width of the laser beam which is subsequently intended to be input into the optical waveguide. The mounting plate need not necessarily be in the form of a plate. The important factor is the planar surface which makes contact with the fibers. In general, a mounting plate therefore also means a mounting element of any desired shape having at least one planar surface. In the case of a multilayer arrangement, the fibers preferably form an at least partially hexagonal arrangement on the mounting plate. Furthermore, the prefabrication comprises fixing of the fibers before the hot-pressing process, in the area of the mounting plate or in the area of the fiber projection which extends over the mounting plate.

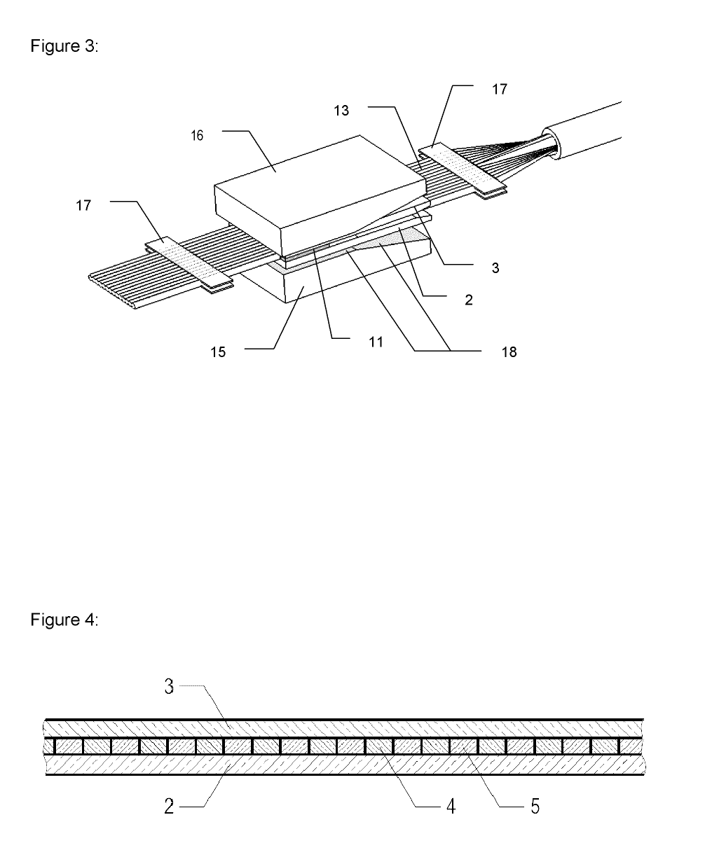

One preferred embodiment of the hot-pressing process is illustrated schematically in FIG. 3. This is preferably done on a vertical axis. The following description from now on assumes this vertical alignment, although this is not absolutely essential. The hot presses which are used for the process preferably include two pressing stamps, which are arranged one on top of the other on a vertical axis and with pressing surfaces aligned with respect to one another, such that this results in a lower pressing stamp with a pressing surface at the top, and an upper pressing stamp with a pressing surface at the bottom. At least one of the two pressing stamps can be moved on a vertical axis. This is preferably the upper pressing stamp, as a result of which a lower pressing stamp is preferably in a fixed position, with an upper pressing stamp which can be moved along a vertical axis. The stamps can be heated. The prefabricated multilayer arrangement is normally heated in a preheating step between the pressing stamps, in which case the upper pressing stamp may produce no force influence or may be applied with a low application force of at most 20 N, in order to improve the heat transfer. A homogeneous temperature distribution within the prefabricated multilayer arrangement can be achieved by the pressing stamps projecting somewhat over the intended fusion area, as is illustrated in FIG. 3. The following shaping step requires the optical fibers to have sufficiently low viscosity. From experience, this temperature corresponds approximately to the softening point E_{W} of the glass materials used for the fibers, where a glass has a viscosity of 10^{7.6} dPa·s. If the optical fibers are composed of a plurality of glass types, the temperatures must be defined to correspond to the glass type with the higher E_{W}. The shaping process is preferably carried out at as low a temperature as possible. During the shaping step, the upper pressing stamp is moved from an initial position to a final position, with the actual shaping movement, in which deformation takes place, representing the compression movement. After a holding time during which the shaping temperature is maintained, the hot-pressing process is ended by a cooling-down step, which is achieved either by reducing the pressing stamp temperatures with the pressing stamps closed, or by slowly opening the pressing stamps. In this case, it is important that the fused multilayer arrangement is not cooled down too quickly, in order to keep the mechanical stresses low. The hot-pressing process is followed by further reworking steps for final fabrication of the input side and of the overall optical waveguide. These comprise the removal of the excess fiber on one side, on the input side, further measures for fixing the pressed fibers and making them robust, end surface machining of the input surface by means of grinding and polishing processes, and, in general, plug and/or flexible tube fitting. By way of example, the remaining intermediate air spaces in the at least partially fused fiber ribbon can be filled with plastics, preferably with adhesive, and the mechanically sensitive transition zone, in particular, can be protected in this way. Silicone encapsulation may also be used, as an alternative. An adhesive is preferably used whose refractive index corresponds approximately to the refractive index of the optical fibers, in particular to the refractive index of the light-guiding core glass. This allows fracture points in individual fibers to be optically glued, and it is at least possible to considerably reduce reflections back into the affected fibers. Furthermore, the spacers can be removed or else remain in the component and be fixed with adhesive. The input end is then sufficiently strong for the mechanical grinding and polishing processes. The fabrication of the input side is followed by further steps for fabrication of the optical waveguide, which in general include flexible tube fitting and fabrication of the output end.

The material of the mounting plate and cover plate is preferably chosen such that it is still sufficiently strong at the shaping temperature and the optical fibers are not molded into the plate during the hot-pressing process. If the mounting plate and cover plate are glass plates, then the softening point E_{W} of the glass should be at least 50 K above the highest E_{W} of the glasses used in the optical fibers, in order to ensure this.

The optical fibers are preferably step-index multimode glass fibers with a uniform fiber diameter D, with the ratio of the cladding thickness to the intended application wavelength being less than 5, particularly preferably between 0.5 and 3.

In one preferred embodiment of the method, the optical fibers are arranged in one layer, parallel and flush on the mounting plate, such that the fibers are arranged in the form of a ribbon with a width and a height. In this case, the fiber ribbon is preferably bounded by side boundary elements and is compressed such that the fibers virtually optimally, that is to say with the highest possible packing density, fill the cross section, at least within a subsection of the fiber ribbon, which is provided for the fusion zone, along the direction of the optical fibers. In the case of a single-layer arrangement the individual fibers are flush alongside one another in this area, and the height of the fiber ribbon corresponds to the fiber diameter D. Outside the subarea of the fiber ribbon which is intended for fusion, it is not absolutely essential for the fibers to be arranged flush or parallel. In this area, by way of example, the fiber ribbon can be subdivided into a plurality of subareas consisting of one or more fibers, and the subareas can likewise be located one on top of the other, and can cross one another. A mixture or else a defined reorganization of the individual fibers or of the subareas mentioned above is likewise possible.

The elements for bounding the fiber ribbon at the side may be removed again after the fiber ribbon has been fixed. In one preferred embodiment of the invention, however, they remain at the side of the fiber ribbon and carry out the function of spacers during the hot-pressing process, that is to say they limit the movement path of the hot presses in conjunction with force-controlled movement control of the hot presses, as will be described further below. Further embodiments are also possible, with a single-piece spacer on one side or both sides of the fixed fiber ribbon. The spacer can likewise be formed integrally with the mounting plate and/or cover plate.

During the hot-pressing process, the fibers are preferably deformed to such an extent that they rest on one another in an form-closed manner, but the cross-sectional area of the individual fibers is not significantly reduced. The individual fibers then preferably form approximately rectangular cross sections, as is illustrated in FIG. 4, with the width of an individual fiber corresponding to the fiber diameter D, and the height theoretically being reduced to about 79% (π/4). However, in practice, discrepancies can occur from this theoretical shape.

In a further preferred embodiment of the method, the optical fibers are arranged in one layer, parallel and at uniform intervals on the mounting plate, with two fibers each having a separation of 0 to five times the fiber diameter D. This embodiment is illustrated schematically in FIG. 5, with the upper part of the figure showing the fibers arranged on the mounting plate, and the lower part of the figure showing the pressed fibers. In this case as well, the fibers are preferably deformed during the hot-pressing process such that they rest on one another in an form-closed manner, although the cross-sectional area of the individual fibers is not significantly reduced. In comparison to a flush arrangement of the fibers, this makes it possible to achieve a smaller gap height for the input gap without changing the fiber diameter, thus reducing the input surface area and improving the beam quality.

A further embodiment of the method is characterized in that after coupling the optical waveguide to a laser diode bar having a plurality of emitters and non-emitting areas between the emitters, only those fibers into which laser radiation is input are combined in an output end, and fibers in which no laser power is input are not supplied to the output end. The optical waveguide according to the invention is preferably coupled to a semiconductor laser having a plurality of emitters, with the input surface of the optical waveguide, which is in the form of a gap, being butt-coupled to the emitter row, or else being coupled to the emitter row via optical elements. In this case, one or more fibers on the input surface are associated with an emitter and with the non-emitting area between two emitters, depending on the emitter width, emitter separation, fiber diameter and the height of the input surface. The fibers into which no laser power is input can be identified after coupling of the semiconductor laser and permanent fixing of the input end and semiconductor laser, and they can be removed from the fiber bundle, and/or cut through. This reduces the total cross-sectional area of the fiber bundle on the output side, correspondingly improving the beam quality.

A further embodiment of the method is characterized in that the optical fibers are arranged in one layer, parallel and in groups of two to five fibers each on the mounting plate, with in each case one group of fibers being associated with an emitter during the subsequent coupling of the input surface of the optical waveguide to a laser diode bar, and with no fibers being arranged in the areas which are associated with the surface between two emitters during the subsequent coupling of the input surface of the optical waveguide to a laser diode bar. This embodiment is illustrated schematically in FIG. 6, with the upper part of the figure showing the fibers which are arranged on the mounting plate, and the lower part of the figure showing the pressed fibers. In this embodiment, there is no need to remove from the bundle fibers into which no radiation need be input after coupling to a semiconductor laser, as described in the previous embodiment. However, groups of fibers must be arranged with exactly the same separation as the emitters.

A further embodiment of the method is characterized in that the fibers are arranged on the mounting plate with a projection on at least one side and, before the hot-pressing process, are temporarily or permanently fixed by suitable means, such as adhesive tape or adhesive at least on one side in the area of this projection. The fixing can be carried out on one side, or preferably on two sides. In the latter case, the fibers are arranged over the mounting plate with a projection on both sides. By way of example, the fiber arrangement can be fixed in the projecting areas by adhesive or an adhesive tape. Temporary or permanent fixing may be provided on the side of the later input surface, and a temporary fixing is preferably used on the opposite side, for example an adhesive tape, which can be removed again before final fabrication of the optical waveguide, without damaging the fibers.

A further embodiment of the method is characterized in that, before the hot-pressing process, the fibers are fixed on the mounting plate in an area which is not pressed during the hot-pressing process. For this purpose, in addition to an area which is intended for the fusion zone and transition zone, the mounting plate preferably comprises a section in which the fibers are preferably fixed relative to the mounting plate before the hot-pressing process. This ensures that the fibers in the transition zone are no longer subject to any mechanical loads after the hot-pressing process. This may be a direct fixing, for example adhesive bonding of the fibers to the mounting plate, although they may also be attached indirectly via elements which are themselves directly or indirectly connected to the mounting plate, for example, the cover plate. The important factor is therefore that the fibers are fixed directly or indirectly by a suitable means relative to the mounting plate, even in the non-pressed area, and are therefore protected against fracturing.

In particular, it has been found to be particularly advantageous to use a light-curing adhesive in conjunction with a transparent cover plate and/or mounting plate. The light-curing adhesive can in this variant be introduced between the mounting plate and the cover plate, and the area in which it spreads out can be deliberately controlled by inputting light through the cover plate and/or mounting plate. In particular, this makes it possible to prevent adhesive from entering the area intended for the fusion zone. Adhesive bonding on the mounting plate can, of course, also be carried out without the presence of a cover plate.

A further embodiment of the method is characterized in that the fibers in the fusion zone are compressed to such an extent that the active cross-sectional area of the input end is filled in an form-closed manner with the optical fibers in the fusion zone, and the total cross-sectional area of the individual fibers in the fusion zone corresponds substantially to the total cross-sectional area of the individual fibers before fusion, or is a maximum of 25% less than this. This means that the fibers are preferably deformed to such an extent that they rest in an form-closed manner on one another, although the cross-sectional area of the individual fibers is reduced by at most 25%, but is preferably not reduced. If the gap height is reduced to a greater extent, this can have a severe adverse effect on the light-guiding properties of the fiber ribbon since a form of compression of the fibers in the axial direction can occur because of a material flow, which is then unavoidable, in the direction of the fiber axis during the fusion process. The compression of the fibers can also deform their optical interface, which can cause the described adverse effect on the light-guiding properties. However, in an individual case and depending on the material combination, it may be advantageous for the total cross-sectional area of the individual fibers in the fusion zone to be slightly less than, or at most 25% less than, the total cross-sectional area of the individual fibers in the unfused fiber bundle. By way of example, this makes it possible to compensate the fluctuations in the individual fiber diameters, or to improve the form-closed connection or fusion. If the gap height were to be reduced to a considerably lesser extent, the deformed fibers would in contrast not rest on one another in an form-closed manner, which could lead to input losses and to a reduction in the mechanical strength of the input end. Fiber ends can likewise be broken out during the final machining.

A further embodiment of the method is characterized in that at least one spacer is fitted to the mounting plate, or is provided as a component of the mounting plate or cover plate, in order to limit the movement distance of the hot press to the side of the fiber bundle. The desired reduction in the gap height is very small since, in the case of single-layer fusion, it is only about 20% of the individual fiber diameter, and is therefore only 10 μm to 20 μm for a typical individual fiber diameter of 50 μm to 100 μm. This very small reduction in the gap height is difficult to implement as a compression movement during hot pressing, since the desired compression movement is actually within the range of the thermal expansions of the components of the hot press. The spacers are preferably used in conjunction with a force-controlled approach to the final position. The force required for compression is for this purpose measured while the pressing stamps are being moved together. When the fiber ribbon has been compressed to such an extent that the upper pressing stamp or the cover plate located on it has reached the spacers, the force rises suddenly, and this is used as a signal to switch off the movement of the upper pressing stamp. Force-controlled approach to the fiber position is also possible without the use of spacers, since the shaping force also rises without spacers, as soon as the fibers have been fused in an form-closed manner and there are no longer any intermediate air spaces there. A more considerable force rise and therefore more precise limiting of the movement distance can be achieved, however, by using spacers. One preferred embodiment of the invention therefore provides for at least one, and preferably two or more spacers, to be applied to the mounting plate on one side or preferably on both sides of the fibers in order to ensure that this very small compression movement is carried out, the thickness of which spacers corresponds to the nominal height of the input surface after fusion. The spacer or spacers can at the same time preferably be the side boundary elements of the fibers, which then carry out a dual function. However, a spacer may also be in the form of a component of the mounting plate or cover plate.

A further embodiment of the method is characterized in that the hot-pressing process is carried out using a pair of opposite pressing stamps, which have a subarea in which the pressing surfaces are planar and parallel to one another, and an adjacent subarea, in which the distance between the pressing surfaces increases uniformly, thus influencing the extent of the transition zone. The inventors have recognized that the extent of the transition zone in the direction of the fibers, in which the cross-sectional shape of the fiber changes from the pressed form to the original form, is of major importance. On the one hand, a change in the cross-sectional shape of an optical fiber within a length which corresponds to a few fiber diameters leads to light being emitted, since the optical interface between the core glass and the cladding glass is then necessarily at a large angle relative to the fiber axis. On the other hand, a transition zone with an excessively short length is also mechanically very sensitive. It has been found that the fusion of a fiber ribbon between a mounting plate and a cover plate of the same shape and size, which are placed flush one on top of the other and are fused over the complete area, is not robust. In this case, the entire area of the fiber ribbon between the mounting plate and the cover plate represents the fusion zone, and a very short transition zone is formed directly outside the mounting plate. The components produced in this way are broken in the area of the transition zone immediately after the hot-pressing process.

In another particularly preferred embodiment of the invention, the extent of the transition zone in the direction of the fibers is therefore increased by using a pair of opposite pressing stamps which have mutually parallel planar pressing surfaces in one subarea, and have an adjacent subarea in which the distance between the pressing surfaces is enlarged increasingly, thus making it possible to deliberately set the width of the transition zone. In this case, the area in which the pressing stamps have the parallel planar pressing surfaces corresponds in the pressed component to the fusion zone, and the area in which the separation of the pressing stamps rises by the compression movement of the press corresponds approximately to the transition zone in the pressed component. For example, one preferred embodiment of the pressing stamps is achieved by a pressing surface having a front area of the pressing surface in which the pressing surface is planar and is at right angles to the pressing direction, and an adjacent rear area of the pressing surface, which is at an angle of about 5°, such that the rear pressing surfaces of the stamp in the hot press include an angle of about 10°. The transition area of the pressing surface between the front and the rear pressing surfaces is in this case preferably slightly rounded. The rear area of the pressing surface need in general not be planar but can, for example, also be curved. The pressing surface which results substantially from two planar surfaces represents the preferred variant from the manufacturing point of view.

A further embodiment of the method is characterized in that a separating means is used to avoid adhesion or sticking of the mounting plate and/or of the cover plate to the pressing stamps. A high-temperature separating means, such as boron nitride, can be applied to the pressing stamp and/or to the prefabricated structure, in order to prevent adhesion of the pressing tools.

A further embodiment of the method is characterized in that further fabrication steps such as measures for fixing and stabilization, for example filling with adhesive, as well as end surface processing, plug and flexible tube fitting, are carried out. In addition, further optical means such as antireflective coatings can be applied to the input surface, or optical lenses, in particular cylindrical lenses, may be arranged in front of it. One special case is represented by an intrinsic cylindrical lens in which the cylindrical lens is formed from the pressed fibers themselves, whose inlet surface is changed to the appropriate cylindrical shape by an appropriate grinding and polishing process. However, the pressed fibers must be very mechanically strong for this grinding and polishing process, and this can be achieved by the present method, since the fibers together with the mounting plate and the cover plate, are very strong. In this case, the cylindrical lenses carry out the function of collimation of the fast axis, and the antireflective coating prevents the input losses resulting from Fresnel reflection.

A further embodiment of the method is characterized in that a cover plate is fitted to the optical fibers before the hot-pressing process and is connected in an form-closed manner to the optical fibers in the uppermost layer of the fibers in the fusion zone during the hot-pressing process. The height of the fiber ribbon then corresponds to the separation between the mounting plate and the cover plate. After the hot-pressing process, a cover plate carries out the task of making the input end more robust. Furthermore, the use of a cover plate prevents direct contact between the upper pressing stamp or a separating means and the optical fibers, which would otherwise be required in order to prevent the fibers from adhering to the upper pressing stamp. However, a cover plate need not necessarily be provided.

The symmetrical design of mounting plate-fibers-cover plate furthermore has the advantage, when using the same materials and material thicknesses for the mounting plate and the cover plate, that the input end has a symmetrical design, and does not bend when temperature gradients occur. In one preferred embodiment of the invention, the cover plate and the mounting plate are therefore composed of the same material with the same material thickness.

The optical waveguide according to the invention is preferably used for coupling to a laser diode bar, preferably to a high-power laser diode bar. By way of example, the radiation from a high-power diode laser can be input through butt-coupling into the input end, produced according to the invention, of an optical waveguide, with the input surface being positioned a short distance in front of the emitter row of the laser bar. Both a butt coupling and a coupling by further optical means such as cylindrical lenses, antireflective layers are covered by the invention, in each case the optical means may be a component of the optical waveguide or of the high-power diode laser, or may be arranged between them.

The optical waveguide according to the invention particularly advantageously allows easier adjustment of the input end in front of the laser diode bar on the axis at right angles to the semiconductor junction. In the optimum case, positioning can be carried out without adjustment, by the laser diode bar and the input end being aligned in front of one another on a common baseplate. This is dependent on the mounting plate having very narrow thickness tolerances, as can be ensured, for example, by float glasses that are available.

Preferred embodiments of the invention will be explained in more detail with reference to the following figures, with FIGS. 1 to 4 showing the embodiment in which the fibers are arranged in a single layer and flush on the mounting plate, and FIGS. 5 and 6 showing the embodiments in which the fibers are arranged at uniform intervals or in groups on the mounting plate.

FIG. 1 shows a schematic perspective view of the input end of the optical waveguide with a single-layer, flush arrangement of the fibers,

FIG. 2 shows a schematic cross section through the input end in the outlet zone with a single-layer, flush arrangement of the fibers,

FIG. 3 shows a schematic perspective view of the input end and of the pressing stamps before the hot-pressing process with a single-layer, flush arrangement of the fibers,

FIG. 4 shows a schematic illustration of the input surface after grinding and polishing with a single-layer, flush and form-closed arrangement of the fibers,

FIG. 5 shows a schematic cross section through the input end in the fusion zone before and after the hot-pressing process with fibers arranged at equal intervals, and

FIG. 6 shows a schematic cross section through the input end in the fusion zone before and after the hot-pressing process with fibers arranged in equidistant groups.

For illustrative purposes, the figures use a schematic illustration, which shows the actual size ratios, but not to scale. The number of optical fibers has also been adapted for illustrative purposes. Further elements which are not essential, such as plug houses, etc., have likewise not been illustrated.

The perspective view in FIG. 1 shows the input end (1) of an optical waveguide according to the invention, comprising the mounting plate (2), the fibers (4, 5), which are connected in an form-closed manner and are deformed on the end surface (6) of the input end, and a cover plate (3). Spacers (11) are arranged on both sides of the fibers, and make area contact with the mounting plate and the cover plate after the hot-pressing process. These are located at the side of the fiber ribbon and extend in the direction of the fibers only over the area or a subarea of the fusion zone (8). The fusion zone (8) is connected to the transition zone (9) and to an outlet zone (10), with the input end (1) being pressed only in the area of the fusion zone (8). The optical fibers (12, 13) are typically combined outside the input end (1) to form a fiber bundle (7), and are surrounded by a flexible tube.

The schematic illustration of the cross section through the input end (1) in the area of the outlet zone in FIG. 2 likewise shows the mounting plate (2) and the cover plate (3), as well as the optical fibers (12, 13). The optical fibers (12, 13) are not fused in this area but have a substantially round cross section. They are embedded in an adhesive (14) in the present example.

The hot-pressing process is illustrated schematically in FIG. 3, and comprises on the one hand the structure, which has been prefabricated for the hot-pressing process, and the upper and lower pressing stamps (16, 15).

The optical fibers (13, 14) in the example form a single-layer fiber ribbon between the mounting plate (2) and the cover plate (3), with spacers (11) adjacent thereto at the side. The fiber ribbon is fixed and held together at the side for the pressing process by fixing means (17) in the area of the fiber projection.

The upper pressing stamp (16) and the lower pressing stamp (15) in the illustrated example are designed to be symmetrical to one another. In addition to the front area of the pressing stamps, in which the pressing surfaces are planar and parallel, the rear area is angled at an angle of about 5°, such that the vertical distance between the pressing surfaces increases uniformly in the area of the subsequent transition zone. The transition area on the pressing surface is preferably slightly rounded. FIG. 3 shows the angle of the pressing surface in a highly exaggerated manner.

The pressing stamps (16, 15) and/or the mounting plate (2) and cover plate (3) are provided with a separating means layer (18) before the hot-pressing process, in order to prevent adhesions.

FIG. 4 schematically illustrates the end surface of the input end (6) with the individual fibers (4, 5) which are connected in an form-closed manner, as well as the mounting plate (2) and the cover plate (3). The cross-sectional shape of the fibers corresponds substantially to a rectangular shape with rounded corners.

FIG. 5 schematically shows a cross section through the input end (1) in the fusion zone (9) with fibers arranged on the mounting plate, before the hot-pressing process (12, 13) in the upper part of the figure and after the hot-pressing process (4, 5) in the lower part of the figure, with the fibers not being arranged flush, but at uniform intervals, according to a further preferred embodiment.

FIG. 6 schematically shows a cross section through the input end (1) in the fusion zone (9) with fibers arranged on the mounting plate, before the hot-pressing process (12, 13) in the upper part of the figure, and after the hot-pressing process (4, 5) in the lower part of the figure, with the fibers not being arranged flush but in groups of three fibers in each case, arranged at equal intervals, according to a further preferred embodiment.

Table 1 shows the material properties of the core glass and cladding glass used for the optical fibers, as well as those for the mounting glass and cover glass.

TABLE 1
Material characteristics of the core, cladding, mounting and cover glass

| | | Core | Core | Cladding | Cladding | Mounting | Mounting | Mounting |
|---|---|---|---|---|---|---|---|---|
| | | glass 1 | glass 2 | glass 1 | glass 2 | glass 1 | glass 2 | glass 3 |
| Coefficient of thermal | [10⁻⁶/K] | 10.3 | 9.5 | 5.0 | 9.1 | 4.5 | 3.2 | 8.6 |
| expansion tα_{20 . . . 300} | | | | | | | | |
| Transition temperature T_{g} | [° C.] | 410 | 398 | 492 | 527 | 660 | 712 | 605 |
| Softening temperature E_{W} | [° C.] | 589 | 575 | 720 | 716 | 880 | 970 | — |
| Refractive index n_{d} | | 1.58 | 1.563 | 1.49 | 1.51 | 1.53 | 1.51 | 1.51 |

The core glass 1 with a thermal expansion of 10.3·10⁻⁶/K together with the cladding glass 1 with a thermal expansion of 5.0·10⁻⁶/K results in a robust optical fiber. An optical waveguide according to the invention can be produced without the fibers fracturing in the input end both with the mounting glass 1 with a thermal expansion of 4.5·10⁻⁶/K and with the mounting glass 3 with a thermal expansion of 8.6·10⁻⁶/K.

The core glass 2 with a thermal expansion of 9.5·10⁻⁶/K together with the cladding glass 2 with a thermal expansion of 9.1·10⁻⁶/K likewise results in a robust optical fiber. However, robust fusion is impossible with this fiber type in conjunction with the mounting glass 2 with a thermal expansion of 3.2·10⁻⁶/K. Severe fiber fracturing occurs. In this case, the thermal expansion of the mounting plate has a value which is lower by 5.9·10⁻⁶/K than the cladding glass, and this leads to tensile stresses during cooling after the fusion in the fibers, and therefore to fracturing.

A further positive example is, furthermore, the combination of core glass 1, cladding glass 2 and mounting glass 3, which likewise results in very high quality, robust fusions.

Furthermore, combinations have been tested in which the thermal expansion of the mounting glass is about 2·10⁻⁶/K to 3·10⁻⁶/K less than the thermal expansion of the cladding glass. In some cases, these exhibit little fiber fracturing and therefore represent approximately the limit of the robust range.

The optical waveguide according to the invention, in particular the input end according to the invention, has numerous advantages over the prior art. On the one hand, it is possible to use easily available optical fibers with a round cross section. The radiation emitted from a laser bar is carried in a relatively small cross section, which means that the beam quality deteriorates only to a minor extent when the radiation is input into the optical waveguide. Furthermore, there is no need to position individual fibers in front of the individual emitters of a laser bar, and all that is necessary is to position the entire fused cross section in front of the emitter row of the laser bar. After adjustment, optical fibers which are located between two emitters of the laser bar can retrospectively be removed from the combined fiber bundle.

The input end has excellent mechanical strength. The fibers are well protected against fracturing in the pressed area and in the critical transition zone, and the input end can be machined using conventional grinding and polishing processes. The optical waveguide and its input end have an excellent input efficiency, since the majority of their end surface is filled with fibers which are connected in an form-closed manner. No losses therefore occur for intermediate spaces between the fibers. Adhesives which can be decomposed by the laser radiation are not used in the area of the light input surface.

A further advantage is the preferably transparent configuration, which allows the use of light-curable adhesives within the input end and for fixing the same, for example on a baseplate. In comparison to thermally curable systems, it is thus possible to considerably reduce the time required for adhesion.

Furthermore, the use of glass as a material for the mount and cover plate has the advantage that the final processing using grinding and polishing processes does not present any problems, and high-quality optical input surfaces are achieved. When using materials which are not the same, such as glass and metal, problems can occur during grinding and polishing, such as swarf formation, smearing of metal particles in the fiber surface and, in particular, non-uniform removal as a result of materials with less grinding hardness being removed to a greater extent.

### LIST OF REFERENCE SYMBOLS

1 Input end
2 Mounting plate
3 Cover plate
4, 5 Optical fibers at least partially connected to one another in an form-closed manner after hot pressing
6 End surface of the input end
7 Fiber bundle
8 Fusion zone
9 Transition zone
10 Outlet zone
11 Spacer
12, 13 Optical fibers with a round cross section/before hot pressing
14 Adhesive
15 Lower pressing stamp
16 Upper pressing stamp
17 Fixing in the area of the fiber projection
18 Separating means layer

1. An optical waveguide, comprising:
a plurality of optical fibers having an input end and one or more output ends, the input end having a fusion zone at least partially connecting the plurality of optical fibers to one another in a form-closed manner;
a transition zone adjacent to the fusion zone, in which the cross section of the plurality of optical fibers changes from a substantially polygonal shape to a substantially circular shape; and
an outlet zone adjacent to the transition zone, in which the plurality of optical fibers have a substantially circular cross-sectional shape,
wherein the plurality of optical fibers are arranged on a mounting plate, and
wherein the plurality of optical fibers in the fusion zone are connected in a form-closed manner to the mounting plate.

2. The optical waveguide as claimed in claim 1, wherein the plurality of optical fibers are step-index multimode glass fibers with a uniform fiber diameter, and wherein the plurality of optical fibers have a ratio of a cladding thickness to an intended application wavelength of less than 5.

3. The optical waveguide as claimed in claim 1, wherein the mounting plate has a linear thermal expansion in the temperature range 20° C. to 300° C. of at most 3·10⁻⁶/K less than, but preferably greater than, a linear thermal expansion in the temperature range 20° C. to 300° C. of a cladding glass of the plurality of optical fibers.

4. The optical waveguide as claimed in claim 1, wherein the plurality of optical fibers are fixed by an adhesive relative to the mounting plate at the outlet zone and/or the transition zone.

5. The optical waveguide as claimed in claim 1, wherein the mounting plate has a surface which faces the plurality of optical fibers having a mean roughness depth R_{z}<1 μm.

6. The optical waveguide as claimed in claim 1, wherein the mounting plate comprises a glass type whose softening temperature is above the highest softening temperature of the glass types used in the plurality of optical fibers.

7. The optical waveguide as claimed in claim 1, wherein the plurality of optical fibers are arranged in one layer, parallel and flush in the area of the transition zone and the fusion zone, have an approximately rectangular cross section in the area of the fusion zone, are arranged in an form-closed manner, and together form an input surface in the form of a gap, whose height is between 60% and 90% of a fiber diameter.

8. The optical waveguide as claimed in claim 1, wherein the plurality of optical fibers are arranged in one layer, parallel at uniform intervals in the transition area from the outlet zone to the transition zone, with each fiber being separated by 0 to five times a fiber diameter, and wherein the plurality of optical fibers together form an input surface in the form of a gap, whose height is between 15% and 90% of the fiber diameter D.

9-10. (canceled)

11. The optical waveguide as claimed in claim 8, wherein the input surface is filled in an form-closed manner in the fusion zone, and the combined cross-sectional area of individual fibers in the fusion zone corresponds essentially to the combined cross-sectional area of the individual fibers in the outlet zone.

12. The optical waveguide as claimed in claim 1, wherein the plurality of optical fibers are connected in an form-closed manner on an upper face to a cover plate in the fusion zone.

13. The optical waveguide as claimed in claim 12, wherein the cover plate has a surface which faces the plurality of optical fibers with a mean roughness depth of R_{z}<1 μm, has a linear thermal expansion in the temperature range 20° C. to 300° C. of at most 3·10⁻⁶/K less than, but preferably greater than, a linear thermal expansion in the temperature range 20° C. to 300° C. of a cladding glass of the plurality of optical fibers, and comprises a glass type whose softening temperature is above the highest softening temperature of the glass types used in the plurality of optical fibers.

14. The optical waveguide as claimed in claim 1, further comprising an optical device selected from the group consisting of accessory lenses, intrinsic cylindrical lenses, and an antireflective coating.

15. A method for production of an optical input end of an optical waveguide comprising a plurality of optical fibers having a substantially circular cross section, comprising:
arranging and fixing the plurality optical fibers in one or more layers on a mounting plate; and
reshaping the plurality of optical fibers using a hot-pressing process, with force and heat, at least in a subarea of the mounting plate such that the plurality of optical fibers are connected to one another at least in groups in an form-closed manner, and the lowermost layer of the plurality of optical fibers is connected in an form-closed manner to the mounting plate, thus resulting in a fusion zone in which the plurality of optical fibers are connected to one another at least in groups in an form-closed manner, and the lowermost layer of the plurality of optical fibers is connected in an form-closed manner to the mounting plate, a transition zone, which is adjacent thereto and in which the cross-sectional shape of the plurality of optical fibers changes from a substantially polygonal shape to a substantially circular shape, and an outlet zone, adjacent thereto, in which the plurality of optical fibers have a substantially circular cross-sectional shape.

16. The method as claimed in claim 15, wherein the plurality of optical fibers are step-index multimode glass fibers with a uniform fiber diameter, and wherein the plurality of optical fibers have a ratio of cladding thickness to intended application wavelength of less than 5.

17. The method as claimed in claim 15, wherein the plurality of optical fibers are arranged in one layer, parallel and flush on the mounting plate.

18. The method as claimed in claim 15, wherein the plurality of optical fibers are arranged in one layer, parallel and at uniform intervals on the mounting plate, with each fiber being separated by 0 to five times a fiber diameter.

19-20. (canceled)

21. The method as claimed in claim 15, wherein the plurality of optical fibers are arranged on the mounting plate with a projection on at least one side and, before the hot-pressing process, are temporarily or permanently fixed at least on one side at the projection.

22. The method as claimed in claim 15, wherein, before the hot-pressing process, the plurality of optical fibers are fixed on the mounting plate in an area which is not pressed during the hot-pressing process.

23. The method as claimed in claim 15, wherein the plurality of optical fibers in the fusion zone are compressed to such an extent that the active cross-sectional area of the input end is filled in an form-closed manner with the optical fibers in the fusion zone, and the total cross-sectional area of the individual fibers in the fusion zone corresponds substantially to the total cross-sectional area of the individual fibers before fusion.

24. The method as claimed in claim 15, further comprising fitting at least one spacer to the mounting plate.

25. The method as claimed in claim 15, wherein the hot-pressing process is carried out using a pair of opposite pressing stamps, which have a subarea in which the pressing surfaces are planar and parallel to one another, and an adjacent subarea, in which the distance between the pressing surfaces increases uniformly, thus influencing the extent of the transition zone.

26. The method as claimed in claim 25, further comprising using a separator to avoid adhesion or sticking of the mounting plate to the pair of pressing stamps.

27-30. (canceled)
